(19) United States
(12) Patent Application Publication
(10) Pub. No.: US 2010/0118389 A1
(43) Pub. Date: May 13, 2010

(54) Ultrafast alexandrite laser amplifier using diode laser sources

(76) Inventor: Joerg Sophus Heinrich, Kreiensen (DE)

Correspondence Address: Joerg Heinrich, Heinrichstrasse 13, Kreiensen, 37547, DE

(21) Appl. No.: 12/291,521

(22) Filed: Nov. 12, 2008

(51) Int. Cl. H01S 3/00

(52) U.S. Cl. 359/342

(57) ABSTRACT

Ultrafast laser amplifier systems based on titanium doped sapphire are useful tools in science and industry. Their wider usage is limited by the high system costs, which results mainly from the use of the solid state pump lasers in the green wavelength range. This invention replaces the titanium doped sapphire amplifier by a diode pumped alexandrite amplifier and so improves the overall system performance and at the same time reduces the cost of the laser system.

### RELATED APPLICATIONS

The present application is related to U.S. Pat. No. 4,272,733, issued Sep. 6, 1981, for BROADLY TUNABLE CHROMIUM-DOPED BERYLLIUM ALUMINATE LASERS AND OPERATION THEREOF, by John C. Walling, Robert C. Morris, Otis G. Peterson, Hans P. Jenssen, included by reference herein.

The present application is related to U.S. Pat. No. 5,488,626, issued Jan. 30, 1996, for METHOD OF AND APPARATUS FOR PUMPING OF TRANSITION METAL ION CONTAINING SOLID STATE LASERS USING DIODE LASER SOURCES, by Donald F. Heller, Timothy C. Chin, Jerzy S. Krasinski, included by reference herein.

### FIELD OF THE INVENTION

The present invention relates to a diode pumped laser amplifier system and, more particularly, to a diode pumped alexandrite laser amplifier system for amplification of ultrafast laser pulses.

### BACKGROUND OF THE INVENTION

Pulsed lasers are a standard tool in science as well as in industry. A special class of pulsed lasers are ultrafast lasers, which generate the highest intensities, drive nonlinear optics and are commonly used in several scientific fields like spectroscopy, metrology and chemistry. These lasers also have a huge potential for industrial applications (i.e. in the car, semiconductor and medical industry), because the high intensities combined with low pulse energies make them precise tools in micromachining without thermal damage. Today ultrafast lasers are already used for drilling and machining of car engines to reduce the fuel consumption or cutting of biological tissue. The main limiting factor of a wider industrial usage of ultrafast laser systems is their low average power.

For most applications of ultrafast pulses, amplification is necessary and the standard material is titanium doped sapphire (Ti:S), which is usually pumped by q-switched, frequency doubled solid state lasers in the green wavelength range. Continuous wave (cw) lasers cannot efficiently pump a ultrafast laser system with typical repetition rates in the few kHz regime, because of the short storage time of Ti:S of 3.2 microseconds at room temperature. The main cost driver in a high average power ultrafast laser system based on Ti:S are the green pump lasers.

Typical ultrafast amplifier systems are based on the chirped pulse amplification technique. First a laser oscillator generates low energy ultrafast pulses with a high repetition rate (MHz), which are stretched in time ten thousand fold, hence reducing their intensity by the same factor. Then a pulse picker selects the pulses to amplify, thus reducing the repetition rate to the kHz range. These stretched pulses can then be amplified without significant nonlinearities or damages in the optical amplifier medium up to a billion fold. Afterwards, the pulses are compressed in time to nearly reproduce the original temporal pulse with a pulse energy amplified according to the amplification factor. The average power of a Ti:S amplifier system is usually below ten Watt and is limited by the power of the q-switched, green pump lasers.

The amplification stage of an ultrafast amplifier is usually divided into two sections, which have different purposes, namely the pre or high gain amplification and the post or power amplification. In the high gain amplification stage the low energy pulses are amplified about a million fold to the watt level of average power. In this regime Ti:S is, at the state of the art, the most suitable material, because it enables high gain and has a broad amplification bandwidth with small gain narrowing characteristics needed for short pulses. The high gain amplification stage is not limited by the available green pump power. The power amplification stage, where amplification factors of only about a hundred are needed, is used to amplify from the watt level to the multi tens of watts level. For this stage Ti:S is not the optimum choice, because for power amplification, high gain and broad amplification bandwidth do not play a major role, since the amplification factor is considerably lower. However, the key role is then played by the available green pump power, and, at the state of the art, suitable green pump lasers are expensive. Replacing the Ti:S power amplifier by a diode pumped power amplifier has two benefits: The costs are significantly reduced and the overall system performance is considerably improved.

Alexandrite (Cr³⁺:BeAl₂O₄) has an optical amplification (700 to 850 nm) in the spectral range of Ti:S and is ideally suited for power amplification. Although alexandrite has lower gain and smaller amplification bandwidth than Ti:S, both are nevertheless absolutely sufficient for power amplification. Usually alexandrite is flash lamp pumped with low efficiency and excessively high heat load generated in the crystal, hence limiting the operational repetition rate (few Hz) and average power. These disadvantages using flash lamp pumping prevented alexandrite from being used for power amplification in high power ultrafast laser systems.

However alexandrite can also be pumped with laser diodes, especially around 680 nm on its R-line absorption. This solution is very attractive for power amplification, because it generates minimal heat load in the crystal due to the small quantum defect and enables very high pump powers. Furthermore alexandrite's storage time of 262 microseconds at room temperature makes it ideal for cw or quasi-cw pumping by laser diodes and eliminates the need for (expensive) q-switched, green pump lasers. The diode pumping with minimal heat load and the long storage time make alexandrite superior to Ti:S for power amplification.

In general ultrafast laser pulses in the spectral range from 700 to 850 nm can be amplified in an alexandrite amplifier. These pulses can be generated by laser systems based on Ti:S, but a variety of alternative laser oscillators and amplifier combinations are possible like: Frequency doubled erbium doped glass, fiber lasers and amplifiers, optical parametric oscillators and amplifiers, Cr³⁺ doped LiSrAlF₆ or nonlinear frequency mixing and combinations thereof.

In conclusion an alexandrite amplifier pumped by laser diodes eliminates the limitation for high power ultrafast laser systems and opens the way for industrial applications.

### SUMMARY OF THE INVENTION

In accordance with the present invention, there is provided an apparatus and method to amplify an ultrafast laser pulse with at least a part of its spectrum in the range of 700 nm to 850 nm in an alexandrite gain medium pumped by at least one laser diode operating at a wavelength shorter than 750 nm and having an average power greater than 1 W.

The diode pumping with minimal heat load and the long storage time make alexandrite ideally suited for amplification of ultrafast pulses and opens the way to high power ultrafast laser systems.

### BRIEF DESCRIPTION OF THE DRAWINGS

A complete understanding of the present invention may be obtained by reference to the accompanying drawing, when considered in conjunction with the subsequent, detailed description, in which:

FIG. 1 is a schematic view of a diode pumped regenerative amplifier comprising an alexandrite gain medium.

For purposes of clarity and brevity, like elements and components will bear the same designations and numbering throughout the FIGURE.

### DESCRIPTION OF THE PREFERRED EMBODIMENT

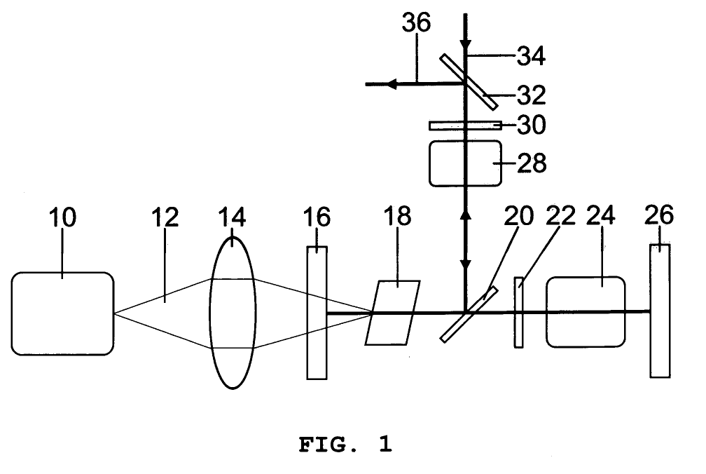

FIG. 1 illustrates an alexandrite laser amplifier according to the present invention. The overall setup is a regenerative amplifier even though the idea holds also for other setups like single or multi pass amplifiers. The general amplifier setup and functionality are well known to persons skilled in the art and will not be discussed in great detail. The preferred embodiment is a regenerative amplifier setup, because alexandrite is a low gain material and the regenerative amplifier allows for as many passes through the alexandrite as needed to reach the desired power level. The energy of an individual ultrafast pulse may increase by as much as 10⁶ before being switched out of the amplifier.

The laser diode 10 provides pump radiation 12, which is optically coupled by the pump optic 14 onto the alexandrite crystal 18 to excite the laser active ions. The pump radiation 12 must be of a wavelength shorter than 750 nm and ideally around 680 nm close to the R-line spectral feature of alexandrite, which ensures sufficient absorption of the pump radiation. The resonant amplifier cavity is formed by the pump mirror 16 and the end mirror 26 and captures the ultrafast input pulses 34, which can be switched in and out of the cavity by the combined action of the Pockels cell 24, the quarter-wave plate 22 and the thin film polarizer 20. These three components are characteristic for a regenerative amplifier. For amplification of the input pulse 34 a part of its spectrum needs to be in the spectral amplification window of the alexandrite crystal 18 between 700 nm and 850 nm. After amplification the pulse leaves the cavity and the output pulse 36 is separated from the input pulse 34 by the combination of the Faraday rotator 28, the half-wave plate 30 and the polarizer 32.

The operation of a regenerative amplifier can be divided into three phases. In the pump phase with Pockels cell 24 at zero voltage, the alexandrite crystal 18 is pumped by the laser diode 10 while laser action is prevented by the quarter-wave plate 22 and the thin film polarizer 20. In the amplification phase the voltage of the Pockels cell 24 is switched to quarter-wave retardation and keeps the pulse between the pump mirror 16 and the end mirror 26 till the desired energy level is reached. In the cavity dump phase the voltage of the Pockels cell 24 is switched to half-wave retardation and the pulse is switched out through the Faraday rotator 28, half-wave plate 30 and polarizer 32 and separated from the input pulse 34.

In this patent and especially in the subsequently appended claims, the term ultrafast laser pulse is defined as a laser pulse with a spectral bandwidth of greater than 5 nm full width at half maximum of the intensity pulse envelope. The ultrafast pulse can be chirped or transform limited and does not need to have short temporal duration.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An apparatus for the amplification of an ultrafast laser pulse with at least a part of its spectrum in the range of 700 nm to 850 nm, comprising:
an alexandrite gain medium; and
means for exciting the alexandrite to amplify said ultrafast laser pulse said exciting means being a pumping source comprising at least one laser diode operating at a wavelength shorter than 750 nm and an average power greater than 1 W.

2. The apparatus in accordance with claim 1, wherein said ultrafast laser pulse is generated by a laser system comprising titanium doped sapphire.

3. The apparatus in accordance with claim 2, wherein said ultrafast laser pulse has an energy greater than 1 micro joule.

4. A method for the amplification of an ultrafast laser pulse with at least a part of its spectrum in the range of 700 nm to 850 nm, comprising the steps of:
generating a laser diode pumping beam at a wavelength shorter than 750 nm and an average power greater than 1 W;
exciting an alexandrite gain medium by impinging said laser diode pumping beam on the alexandrite, so as to excite the alexandrite; and
amplifying said ultrafast laser pulse in the alexandrite.

5. The method in accordance with claim 4, wherein said ultrafast laser pulse is generated by a laser system comprising titanium doped sapphire.

6. The method in accordance with claim 5, wherein said ultrafast laser pulse has an energy greater than 1 micro joule.
